(19) United States
(12) Patent Application Publication
(10) Pub. No.: US 2025/0300786 A1
(43) Pub. Date: Sep. 25, 2025

(54) REDUCTION OF A CONTROL PLANE SECTION SIZE FOR AN INTERLEAVED PHYSICAL DOWNLINK CONTROL CHANNEL CONTROL RESOURCE SET 0

(71) Applicant: QUALCOMM Incorporated, San Diego, CA (US)

(72) Inventors: Akashnil ROY, Kolkata (IN); Tushar SINGH, Hyderabad (IN); Orod RAEESI, Espoo (FI)

(21) Appl. No.: 18/613,612

(22) Filed: Mar. 22, 2024

(51) Int. Cl. H04L 5/00

(52) U.S. Cl. CPC H04L 5/0053

(57) ABSTRACT

Various aspects of the present disclosure generally relate to wireless communication. In some aspects, a distributed unit (DU) may receive an indication that a radio unit (RU) supports a control plane (C-Plane) section size reduction format. The DU may transmit, based at least in part on receiving the indication, a C-Plane message that uses the C-Plane section size reduction format, the C-Plane message indicating a resource allocation for an interleaved physical downlink control channel (PDCCH) control resource set (CORESET) 0. Numerous other aspects are described.

### FIELD OF THE DISCLOSURE

Aspects of the present disclosure generally relate to wireless communication and specifically relate to techniques, apparatuses, and methods for reduction of a control plane section size for an interleaved physical downlink control channel control resource set 0.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a distributed unit (DU). The method may include receiving an indication that a radio unit (RU) supports a control plane (C-Plane) section size reduction format. The method may include transmitting, based at least in part on receiving the indication, a C-Plane message that uses the C-Plane section size reduction format, the C-Plane message indicating a resource allocation for an interleaved physical downlink control channel (PDCCH) control resource set (CORESET) 0.

Some aspects described herein relate to a method of wireless communication performed by an RU. The method may include transmitting an indication that the RU supports a C-Plane section size reduction format. The method may include receiving, based at least in part on receiving the indication, a C-Plane message that uses the C-Plane section size reduction format, the C-Plane message indicating a resource allocation for an interleaved PDCCH CORESET 0.

Some aspects described herein relate to an apparatus for wireless communication at a DU. The apparatus may include one or more memories and one or more processors coupled to the one or more memories. The one or more processors may be configured to receive an indication that an RU supports a C-Plane section size reduction format. The one or more processors may be configured to transmit, based at least in part on receiving the indication, a C-Plane message that uses the C-Plane section size reduction format, the C-Plane message indicating a resource allocation for an interleaved PDCCH CORESET 0.

Some aspects described herein relate to an apparatus for wireless communication at an RU. The apparatus may include one or more memories and one or more processors coupled to the one or more memories. The one or more processors may be configured to transmit an indication that the RU supports a C-Plane section size reduction format. The one or more processors may be configured to receive, based at least in part on receiving the indication, a C-Plane message that uses the C-Plane section size reduction format, the C-Plane message indicating a resource allocation for an interleaved PDCCH CORESET 0.

Some aspects described herein relate to a non-transitory computer-readable medium that stores a set of instructions for wireless communication by a DU. The set of instructions, when executed by one or more processors of the DU, may cause the DU to receive an indication that an RU supports a C-Plane section size reduction format. The set of instructions, when executed by one or more processors of the DU, may cause the DU to transmit, based at least in part on receiving the indication, a C-Plane message that uses the C-Plane section size reduction format, the C-Plane message indicating a resource allocation for an interleaved PDCCH CORESET 0.

Some aspects described herein relate to a non-transitory computer-readable medium that stores a set of instructions for wireless communication by an RU. The set of instructions, when executed by one or more processors of the RU, may cause the RU to transmit an indication that the RU supports a C-Plane section size reduction format. The set of instructions, when executed by one or more processors of the RU, may cause the RU to receive, based at least in part on receiving the indication, a C-Plane message that uses the C-Plane section size reduction format, the C-Plane message indicating a resource allocation for an interleaved PDCCH CORESET 0.

Some aspects described herein relate to an apparatus for wireless communication. The apparatus may include means for receiving an indication that an RU supports a C-Plane section size reduction format. The apparatus may include means for transmitting, based at least in part on receiving the indication, a C-Plane message that uses the C-Plane section size reduction format, the C-Plane message indicating a resource allocation for an interleaved PDCCH CORESET 0.

Some aspects described herein relate to an apparatus for wireless communication. The apparatus may include means for transmitting an indication that the apparatus supports a C-Plane section size reduction format. The apparatus may include means for receiving, based at least in part on receiving the indication, a C-Plane message that uses the C-Plane section size reduction format, the C-Plane message indicating a resource allocation for an interleaved PDCCH CORESET 0.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIGS. 4A and 4B are diagrams illustrating a first example and a second example, respectively, of communications that may be used by one or more network nodes in an open radio access network, in accordance with the present disclosure.

FIG. 5 is a diagram illustrating an example of a wireless communication process between a distributed unit (DU) and a radio unit (RU), in accordance with the present disclosure.

FIG. 6 is a diagram illustrating an example of a chart that illustrates a comparison of various resource block group (RBG) sizes that may be used in a control plane (C-Plane) message to indicate example physical resource block (PRB) partitions of an interleaved physical downlink control channel (PDCCH) control resource set (CORESET) 0 in a C-Plane message, in accordance with the present disclosure.

FIG. 7 is a diagram illustrating an example of a chart that illustrates a comparison of various RBG sizes that may be used in a C-Plane message to indicate example PRB partitions of an interleaved PDCCH CORESET 0 in a C-Plane message, in accordance with the present disclosure.

FIG. 8 is a diagram illustrating an example of a chart that illustrates a comparison of various RBG sizes that may be used in a C-Plane message to indicate example PRB partitions of an interleaved PDCCH CORESET 0 in a C-Plane message, in accordance with the present disclosure.

FIG. 9 is a diagram illustrating an example process performed, for example, at a DU or an apparatus of a DU, in accordance with the present disclosure.

FIG. 10 is a diagram illustrating an example process performed, for example, at a RU or an apparatus of a RU, in accordance with the present disclosure.

FIG. 11 is a diagram of an example apparatus for wireless communication, in accordance with the present disclosure.

FIG. 12 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Network nodes of a disaggregated base station used in an open radio access network (O-RAN) may communicate with one another using a variety of messages to provide service to a user equipment (UE) via an access link. As one example, a distributed unit (DU) may transmit a control plane (C-Plane) message to a radio unit (RU) to manage and/or control access to the network, such as management and/or control of the UE access link. For instance, C-Plane messages may be used to establish and/or maintain the access link with a UE. Some non-limiting example C-Plane messages may include resource allocation messages (e.g., for establishing and/or communicating via the access link), mobility management messages, and configuration messages. As one example, a C-Plane message may be used to configure an interleaved PDCCH that dynamically allocates one or more PDCCH resources across multiple subframes.

In some aspects, at least some resources of the interleaved PDCCH may be used as control resource set (CORESET) 0 resources that are used to carry downlink control signaling. However, a formatting of information used by the C-Plane message (e.g., a section and/or a section extension) may result in inefficient use of communication resources (e.g., air interface resources). To illustrate, a communication standard may specify one or more operating conditions related to a resource location of a CORESET 0. For example, the communication standard may specify an operating condition that a starting resource (e.g., a physical resource block (PRB)) of the CORESET 0 occurs at an integer multiple of six (6) to simplify resource allocation and/or scheduling. However, a resource allocation for an interleaved PDCCH may not begin at an integer multiple of 6, resulting in the C-Plane message using multiple sections and/or section extensions to provide a configuration of the interleaved PDCCH for a CORESET 0. Increasing a number of sections and/or section extensions in a C-Plane message may lead to increased message resource consumption by the C-Plane message, resulting in fewer message resources being available for other O-RAN messages, slower communication transfers (e.g., increased communication latencies), reduced data throughput, and/or congestion within the O-RAN.

Various aspects relate generally to providing reduction to a C-Plane section size for interleaved PDCCH CORESET 0. Some aspects more specifically relate to a network node (e.g., a DU and/or an RU) validating that a resource allocation configuration for an interleaved PDCCH CORESET 0 enables use of a C-Plane section size reduction format for a C-Plane message. In some aspects, a DU may receive an indication that an RU supports a C-Plane section size reduction format. Based at least in part on receiving the indication, the DU may generate a C-Plane message based at least in part on using the C-Plane section size reduction format. In some cases, the DU may use the C-Plane section size reduction format based at least in part on verifying and/or validating a resource allocation configuration, as described below. Examples of a C-Plane section size reduction format may include configuring an SE-6 and/or an SE-12 in a C-Plane message based at least in part on C-Plane section reduction validation logic and/or a C-Plane section size reduction equation, and/or including a C-Plane interleaved PDCCH CORESET 0 extension (e.g., that is not an SE-6 or an SE-12) in the C-Plane message as described below. Based at least in part on generating the C-Plane message using the C-Plane section size reduction format, the DU may transmit the C-Plane message, and the C-Plane message may indicate a resource allocation for an interleaved PDCCH CORESET 0.

In some aspects, an RU may transmit an indication that the RU supports a C-Plane section size reduction format, such as an SE-6 and/or an SE-12 that is based at least in part on C-Plane section reduction validation logic and/or a C-Plane section size reduction equation and/or a C-Plane interleaved PDCCH CORESET 0 extension. Based at least in part on transmitting the indication, the RU may receive a C-Plane message that uses the C-Plane section size reduction format. In some aspects, the C-Plane message may indicate a resource allocation for an interleaved PDCCH CORESET 0 using fewer sections and, consequently, fewer communication resources, relative to a another C-Plane message that is based at least in part on the baseline calculations described above.

Particular aspects of the subject matter described in this disclosure can be implemented to realize one or more of the following potential advantages. In some examples, by using a C-Plane section size reduction format in a C-Plane message to indicate an interleaved PDCCH CORESET 0, the described techniques can be used to enable a DU to transmit a first C-Plane message that uses fewer sections and, consequently, fewer communication resources, relative to a second C-Plane message that is generated using baseline calculations as described below. Using fewer communication resources may reduce message resource consumption (e.g., air interface resources) by the C-Plane message, increase a number of message resources being available for other O-RAN messages, reduce communication transfer latencies, increase data throughput, and/or reduce congestion within the O-RAN.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

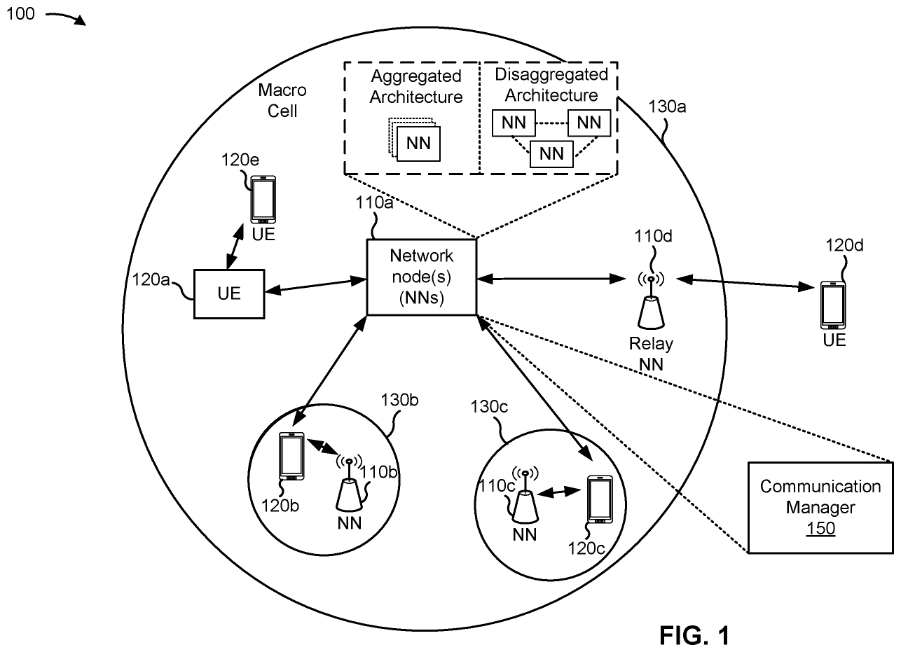

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, a DU (e.g., a network node 110 and/or a DU 330) may include a communication manager 150. As described in more detail elsewhere herein, the communication manager 150 may receive an indication that an RU supports a C-Plane section size reduction format; and transmit, based at least in part on receiving the indication, a C-Plane message that uses the C-Plane section size reduction format, the C-Plane message indicating a resource allocation for an interleaved physical downlink control channel (PDCCH) CORESET 0. Additionally, or alternatively, the communication manager 150 may perform one or more other operations described herein.

In some aspects, an RU (e.g., a network node 110 and/or an RU 340) may include a communication manager 150. As described in more detail elsewhere herein, the communication manager 150 may transmit an indication that the RU supports a C-Plane section size reduction format; and receive, based at least in part on receiving the indication, a C-Plane message that uses the C-Plane section size reduction format, the C-Plane message indicating a resource allocation for an interleaved PDCCH CORESET 0. Additionally, or alternatively, the communication manager 150 may perform one or more other operations described herein.

As indicated above, FIG. 1 is provided as an example. Other examples may differ from what is described with regard to FIG. 1.

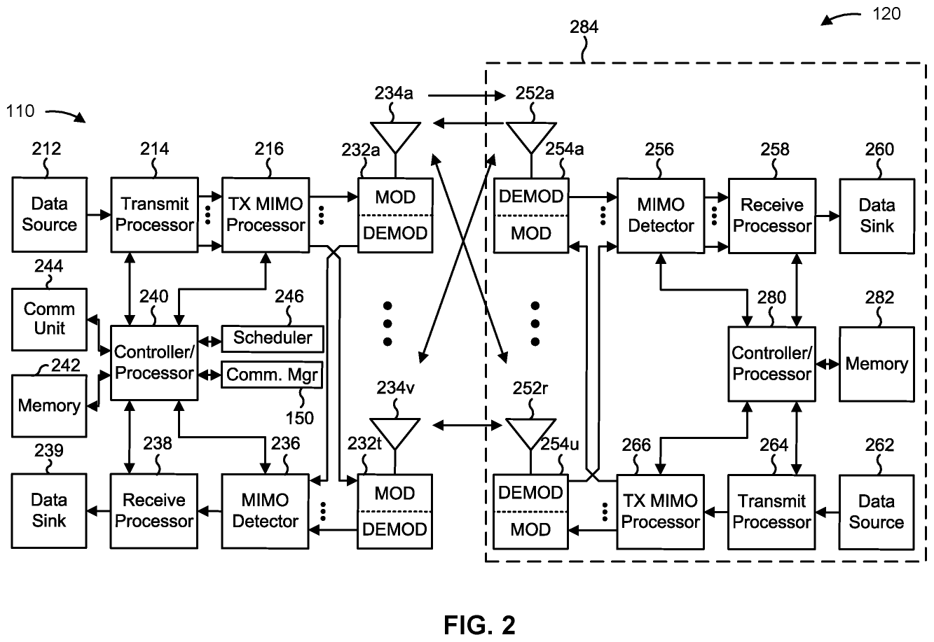

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

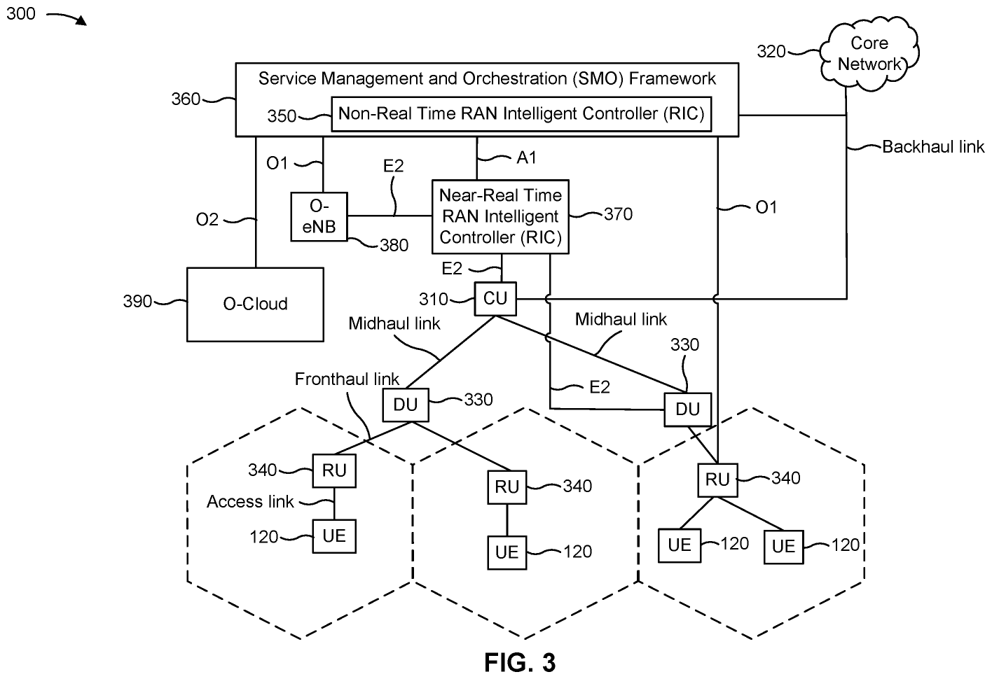

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

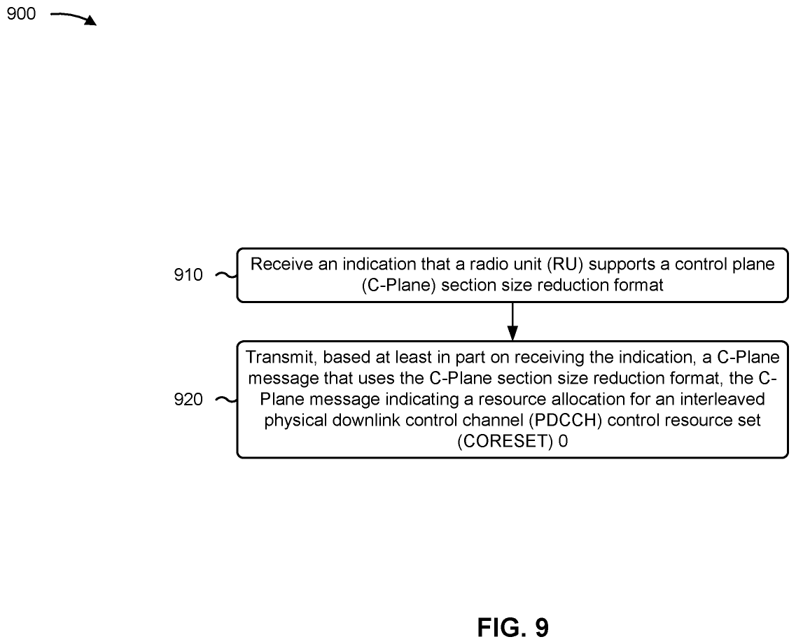

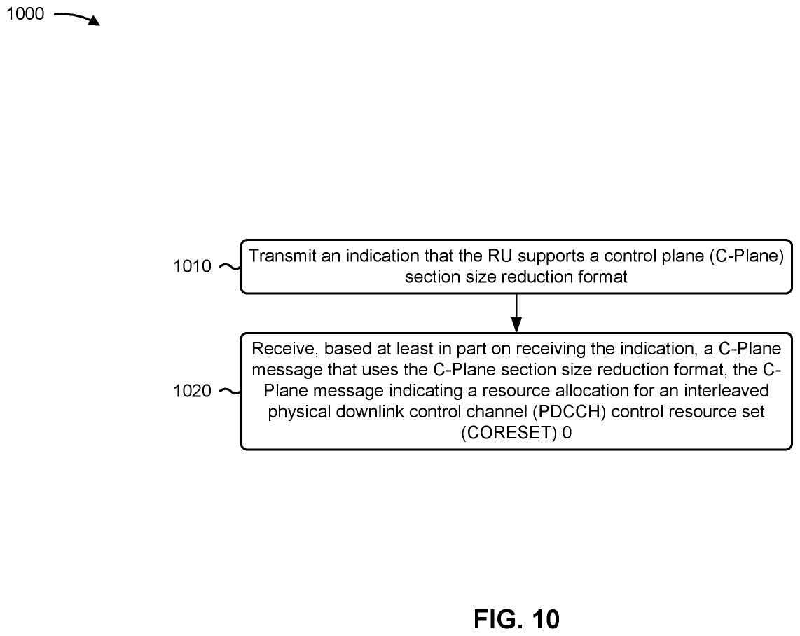

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with an interleaved PDCCH CORESET 0, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 900 of FIG. 9, process 1000 of FIG. 10, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 900 of FIG. 9, process 1000 of FIG. 10, or other processes as described herein. In some examples, executing instructions may include running the instructions, converting the instructions, compiling the instructions, and/or interpreting the instructions, among other examples.

In some aspects, a DU (e.g., a network node 110 and/or a DU 330) includes means for receiving an indication that an RU supports a C-Plane section size reduction format; and/or means for transmitting, based at least in part on receiving the indication, a C-Plane message that uses the C-Plane section size reduction format, the C-Plane message indicating a resource allocation for an interleaved PDCCH CORESET 0. In some aspects, the means for the DU to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

In some aspects, an RU (e.g., a network node 110 and/or an RU 340) includes means for transmitting an indication that the RU supports a C-Plane section size reduction format; and/or means for receiving, based at least in part on receiving the indication, a C-Plane message that uses the C-Plane section size reduction format, the C-Plane message indicating a resource allocation for an interleaved PDCCH CORESET 0. In some aspects, the means for the RU to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

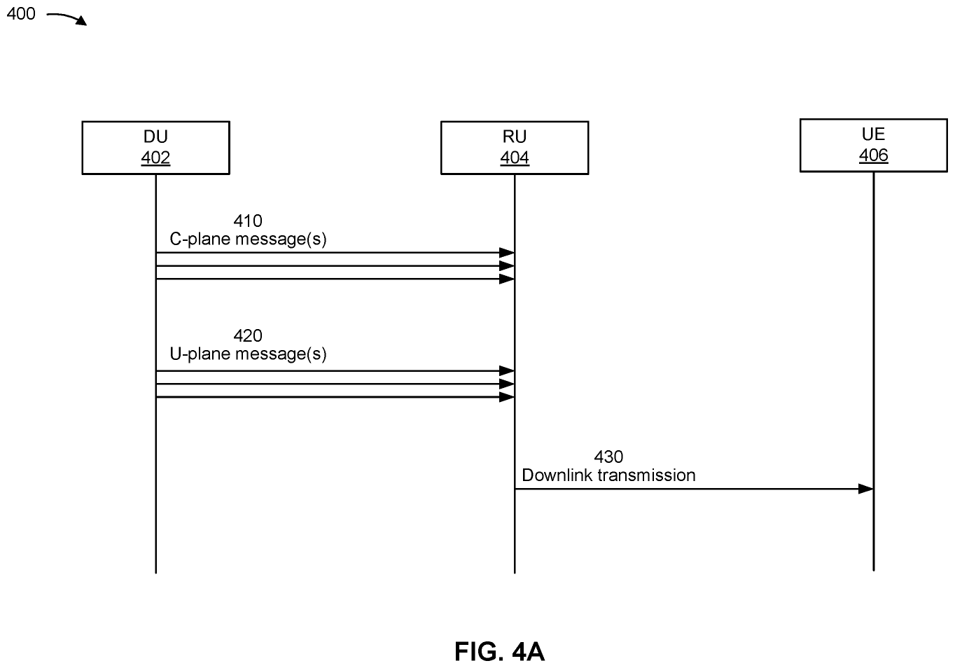

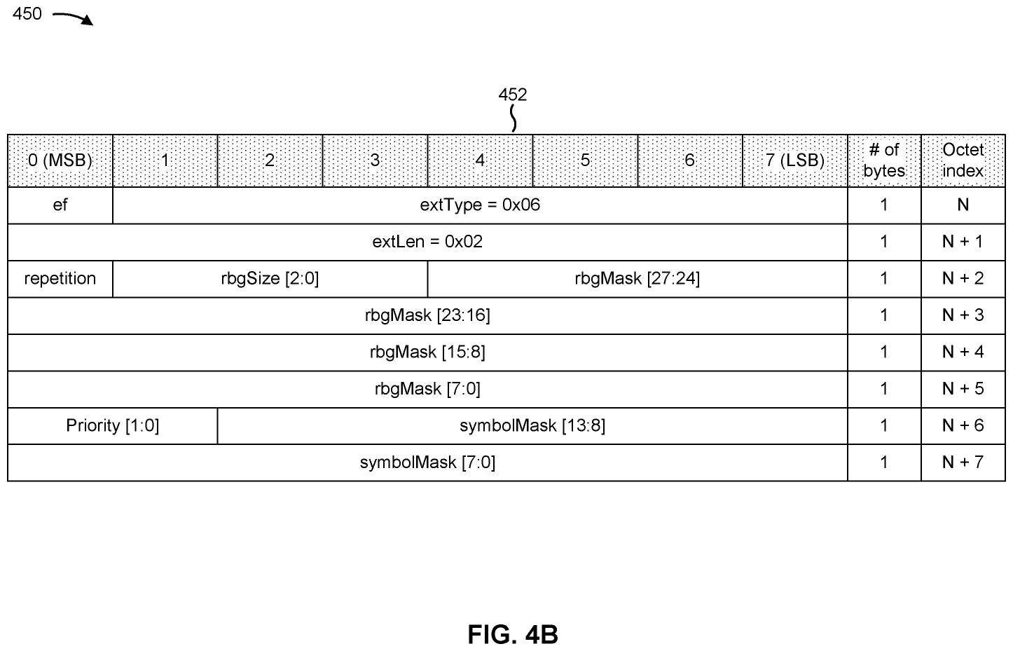

FIGS. 4A and 4B are diagrams illustrating a first example 400 and a second example 450, respectively, of communications that may be used by one or more network nodes in an O-RAN, in accordance with the present disclosure.

As described with regard to FIG. 3, the components and/or network nodes of a disaggregated base station used in an O-RAN may communicate with one another using a variety of messages to provide service to a UE via an access link. Some example messages may include service plane (S-Plane) messages, management plane (M-Plane) messages, C-Plane messages, and/or user plane (U-Plane) messages. The various messages may be communicated between the components and/or network nodes using one or more wired links and/or one or more wireless links.

S-Plane messages may be used to provide services to a UE, such as call setup services and/or mobility management services. Non-limiting examples of S-plane messages include service provisioning messages, service management messages, and/or service control messages.

M-plane messages may be used to manage various network elements (e.g., components and/or network nodes in the O-RAN), network resources, and/or network operation. To illustrate, M-Plane messages may be used to manage a network configuration, network fault detection, network performance management, and/or network security management. Some non-limiting examples of M-Plane messages may include network element configuration messages, performance queries, performance responses, and fault detection messages.

C-Plane messages may be used to manage and/or control access to the network, such as management and/or control of an access link. For instance, C-Plane messages may be used to establish and/or maintain an access link with a UE. Some non-limiting example C-Plane messages may include resource allocation messages (e.g., for establishing and/or communicating via the access link), mobility management messages, and configuration messages.

U-Plane messages may be used to manage and/or control user data traffic transmitted and/or received via an access link. Some non-limiting example U-Plane messages may include data packet messages, user data frames, segmentation and/or reassembly messages, and/or payload data. In some aspects, U-Plane messages may include information for particular types of downlink control information (DCI) that may be carried by a data traffic transmission, such as scheduling DCI, power control DCI, and/or channel quality indicator (CQI) DCI. In other aspects, DCI may be configured via C-Plane messages (e.g., without the use of U-Plane messages).

The first example 400, shown by FIG. 4A, is an example of communications that may occur between a DU 402 (e.g., a DU 330 and/or a first network node 110) and an RU 404 (e.g., an RU 340 and/or a second network node 110) to generate a downlink data transmission to a UE 406 (e.g., a UE 120) via an access link. As shown by reference number 410, the DU 402 may communicate, and the RU 404 may receive, one or more C-Plane messages. As described above, the DU 402 and the RU 404 may communicate with one another via a wireless communication link and/or a wired communication link. In some aspects, the C-Plane messages may indicate, to the RU 404, any combination of a resource allocation, an MCS, beamforming instructions, and/or a power control configuration to use for the downlink data transmission.

As shown by reference number 420, the DU 402 may communicate, and the RU 404 may receive, one or more U-plane messages. As one example, the U-Plane message(s) may include payload data and/or data packet(s) to include in the downlink data transmission.

As shown by reference number 430, the RU 404 may transmit, and the UE 406 may receive, a downlink transmission. In some aspects, the RU 404 may generate the downlink transmission using configuration information indicated by the C-plane message(s), such as resource allocation configuration information (e.g., a frequency band and/or a time resource), a power level, a beamforming and/or antenna configuration, CQI reporting configuration, and/or a scheduling configuration. While the example 400 shown by FIG. 4A includes an example of a C-Plane message being used to configure a downlink data transmission, other examples may include a C-Plane message being used to configure a downlink control message, an uplink data traffic message, and/or an uplink control message. Some non-limiting examples may include DCI, scheduling messages (e.g., timing, frequency, and/or duration information), system information broadcasts, paging messages, and/or acknowledgment/negative acknowledgement (ACK/NACK) messages.

A C-Plane message may indicate the configuration information using a variety of formats. To illustrate, a C-Plane message may include a header section that provides information about a message type carried by the C-Plane message, a message length of the C-Plane message, a source identifier (ID), a destination ID, and/or a protocol version. Alternatively, or additionally, the C-Plane message may include a payload (e.g., the configuration information), and the format and/or information of the payload may vary based at least in part on a message type of the C-Plane message. For instance, the payload of a configuration message type may indicate configuration information that instructs a network node (e.g., an RU) regarding what configuration to use for transmitting and/or receiving a signal (e.g., resource allocation parameter(s), an MCS, a power control setting, a beamforming configuration, and/or an antenna configuration), while the payload of a mobility management message type may indicate UE mobility parameters (e.g., handover parameters, a measurement report from a UE, and/or mobility control commands).

In some aspects, a C-Plane message may include one or more sections, and each section may indicate information about a respective group of resources and/or a respective resource allocation. Alternatively, or additionally, each resource allocation may be based at least in part on time domain partitioning and/or frequency domain partitioning through the use of any combination of symbols, resource blocks (RBs), resource block groups (RBGs), and/or physical resource blocks (PRBs). In some aspects, an RB may include multiple contiguous PRBs, and an RBG may include multiple contiguous RBs. Accordingly, in order from smallest to largest, a PRB is included in an RB, and an RB is included in an RBG.

Information in a C-Plane message that describes one or more characteristics about a resource allocation may alternatively be referred to as a “section description” and/or a “section structure,” and a C-Plane message may include different types of section descriptions and/or different types of section structures to indicate different information about different section types. For instance, a C-Plane message may include a Section Type 0 structure that indicates information about idle and/or guard periods, a Section Type 1 structure that indicates information about downlink and/or uplink radio channels, a Section Type 3 structure that indicates information about a physical random access channel (PRACH), a Section Type 5 structure that indicates information about UE scheduling, a Section Type 6 structure that indicates channel information directed to a specific UE identifier (ID), and/or a Section Type 7 structure that indicates information about licensed assisted access (LAA). Example information that may be include in a Section Type structure may include a starting physical resource block combination (startPrbc) field, a number of PRBs that are configured (numPrbc) field, and/or resource block (rb) field. In some aspects, the startPrbc field may indicate a starting PRB (e.g., an index of the starting PRB) in a resource group, the numbPrbc field may indicate a number of PRBs in the resource group, and the rb field may indicate whether every RB, or every other RB, within a grouping (e.g., an RBG) is used. For instance, for a scenario in which startPrbc=1 and numPrbc=3, setting the rb field to a first value (e.g., “0”) may indicate that every RB is used (e.g., RB 1, RB 2, and RB 3), and setting the rb field to a second value (e.g., “1”) may indicate that every other RB is used (e.g., RB 1, RB 3, and RB 5). Alternatively, or additionally, a Section Type structure may include a number of symbols (numSymbol) field that indicates a length and/or duration of a message in units of symbols.

As one example, a C-Plane message may be used to configure an interleaved PDCCH that dynamically allocates one or more PDCCH resources across multiple subframes. In some aspects, the interleaved PDCCH may be based at least in part on a pattern, such as a repetition pattern that repeats a same PDCCH message across the multiple subframes, a frequency hopping pattern that interleaves PDCCH resources across different frequency resources within a subframe, a time division multiplexing (TDM) pattern that interleaves PDCCH resources across different time slots within a subframe, and/or a spatial diversity pattern that interleaves PDCCH resources across multiple antennas and/or transmission paths within a subframe. The patterns used to configure interleaved PDCCH may improve a spectral efficiency of communications transmitted via the PDCCH. In some aspects, at least some resources of the interleaved PDCCH may be used as CORESET 0 resources that are used to carry downlink control signaling.

The second example 450, shown in FIG. 4B, includes an example of a section extension 6 (SE-6) format 452 that may be included in a C-Plane message to provide information about a resource allocation. In some aspects, the SE-6 may be considered additional information and/or supplemental information to Section Type information. To illustrate, information included in the SE-6 format 452 may be used in combination with information included in a Section Type 1 structure, a Section Type 3 structure, and/or a Section Type 5 structure. In some aspects, the SE-6 format 452 may be used in a C-Plane message to indicate a resource allocation that is based at least in part on non-contiguous PRBs, such as non-contiguous PRBs that are part of an interleaved PDCCH resource allocation. While the SE-6 format 452 may be used to indicate a resource allocation associated with an interleaved PDCCH, other section extensions may alternatively or additionally be used to indicate a resource allocation for an interleaved PDCCH, such as a section extension 12 (SE-12) format. The SE-6 format 452 shown in FIG. 4B is partitioned into eight (8) rows, and each row includes 8 bits that are ordered from the most significant bit (MSB) (e.g., bit 0) to the least significant bit (LSB) (e.g., bit 7).

Bit 0 of the first row is configured as an extension flag (ef) that may be set to a first value (e.g., “0”) to indicate that no other extension for a Section Type structure is included in the C-Plane message, and a second value (e.g., “1”) to indicate that another extension for the Section Type structure is included after the SE-6 information. Bits 1-7 of the first row are configured as an extension type (extType) field that indicates the extension type and/or format of the information included in the extension information. For example, and as shown by FIG. 4B, the extType field may be set to 0x06 to indicate that the supplemental information is formatted and/or includes information specified by the SE-6 format 452.

Bits 0-7 of the second row are configured as an extension length (extLen) field that provides a length of the extension in terms of 32-bit and/or 4-byte words. For example, and as shown by FIG. 4B, the extLen field may be set to 0x02 to indicate that the supplemental information has a length of 2 words.

Bit 0 of the third row is configured as a repetition flag that, based at least in part on the existence (and/or no existence) of C-Plane and U-Plane coupling via frequency and time with priorities, may be set to a first value (e.g., “0”) to indicate that there are no duplicated section descriptions (e.g., no duplicated parameters and/or fields), and/or may be set to a second value (e.g. “1”) to indicate that a section description (e.g., a parameter and/or field) is duplicated. Bits 1-3 of the third row are configured as a resource block group size (rbgSize) field that indicates a size (e.g., a number) of PRBs in resource block groups that are allocated by a bit mask, as described below. In some aspects, the rbgSize field may be configured as follows:
000b=reserved value
001b=1 PRB/RB
010b=2 PRBs/RB
011b=3 PRBs/RB
100b=4 PRBs/RB
101b=6 PRBs/RB
110b=8 PRBs/RB
111b=16 PRBs/RB

Bits 4-7 of the third row are configured as a first portion of a resource block group bit mask (rbgMask), bits 0-7 of the fourth row are configured as a second portion of the rbgMask, bits 0-7 of the fifth row are configured as a third portion of the rbgMask, and bits 0-7 of the sixth row are configured as a fourth portion of the rbgMask. In total, the rbgMask shown by FIG. 4B includes 28 bits, and each portion represents particular bits of the rbgMask. For example, the first portion represents bits 27-24, the second portion represents bits 23-16, the third portion represents bits 15-8, and the fourth portion represents bits 7-0. Each bit of the bit mask is associated with a respective resource block group (RBG), and a respective value of each bit indicates whether or not the respective RBG is included in the resource allocation.

Bits 0 and 1 of the seventh row are configured as a priority field. In some aspects, the priority field may indicate a priority level that is assigned to a particular message and/or element of the particular message that is carried in the resource allocation. Bits 2-7 of the seventh row are configured as a first portion of a symbol mask (symbolMask) field, and bits 0-7 of the eighth row are a second portion of the symbol mask. In total, the symbolMask field shown by FIG. 4B includes 14 bits, where the first portion are the MSBs of the symbolMask field (e.g., bits 13-8) and the second portion are the LSBs of the symbolMask field (e.g., bits 7-0). In some aspects, each bit in the symbolMask field indicates whether the rbgMask applies to a particular symbol in a time slot. For instance, the value of the n-th bit in the symbolMask, n being an integer, may indicate whether or not the rbgMask should be applied to the n-th symbol.

An RU (e.g., an RU 340, the RU 404, and/or a network node 110) may use information indicated in a Section Type in combination with information indicated in a section extension (e.g., an SE-6 and/or an SE-12) to configure a first transmission and/or to receive a second transmission. For example, the RU may determine to use the rbgMask field based at least in part on the rbgSize field being set to a value greater than zero, and/or the UE may determine which RBGs to use based at least in part on using information that is indicated by a combination of the Section Type information and the section extension information. For example, the RU may calculate a last potential allocated RBG (lastRbgid) using the following baseline calculation:

lastRbgid=ceiling((numPrbc+(startPrbc mod rbgSize))/rbgSize)=1

where allocation of the last RBG may be based at least in part on a corresponding bit in the rbgMask field. Alternatively, or additionally, the RU may calculate a range of PRBs included in an RBG using the following baseline calculation:

PRB range=[startPrbc,startPrbc+f(0)−1]

where f(n) provides a number of PRBs included in a particular RBG (e.g., an n-th RBG, n being an integer) and may be computed using the following baseline computations:

f(0)=rbgSize−(startPrbc mod rbgSize)

f(n)=rbgSize, where 0<n<lastRbgid

if (startPrbc+numPrbc)mod rbgSize>0 then

f(lastRbgid)=(startPrbc+numPrbc)mod rbgSize

else

f(lastRbgid)=rbgSize

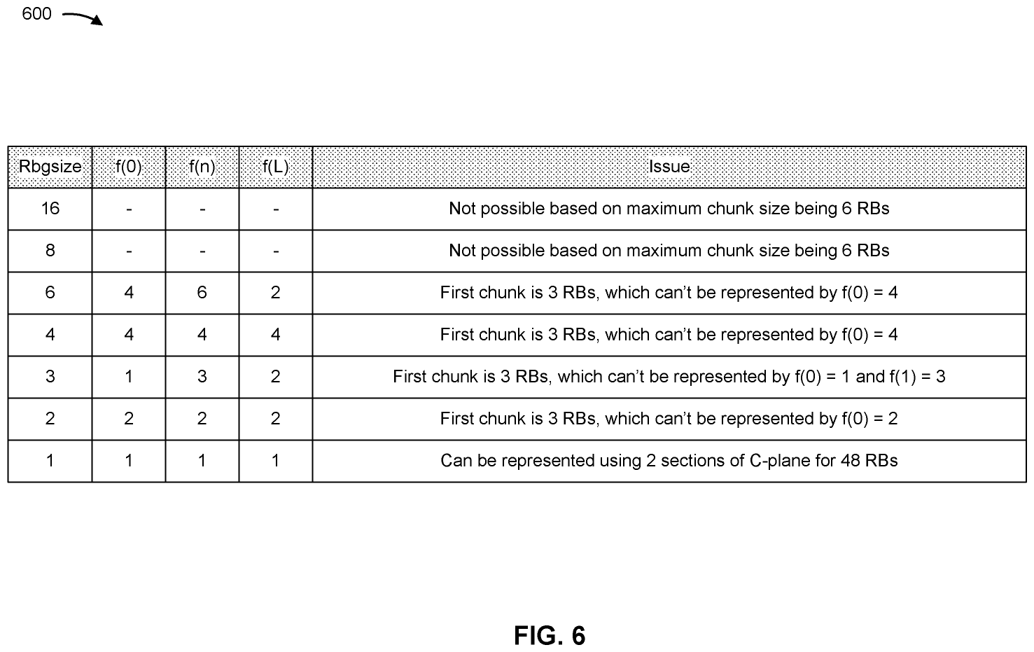

In some aspects, the format of information included in a section extension, such as SE-6, may lead to an inefficient C-Plane message (e.g., a C-Plane message that uses more communication resources than needed to convey information). To illustrate, a DU may indicate, to an RU, a CORESET 0 allocation that is based at least in part on an interleaved PDCCH using one C-Plane message. However, a communication standard may specify one or more operating conditions related to a resource location of a CORESET 0. To illustrate, the communication standard may specify an operating condition that a start PRB of the CORESET 0 occurs at an integer multiple of 6 to simplify resource allocation and/or scheduling. As one example, a resource allocation unit (e.g., an RBG) used by the communication standard may be based at least in part on the multiple of 6, such that the start PRB of the CORESET 0 occurring at an integer multiple of 6 leads to more efficient use of air interface resources and/or less waste of air interface resources. For instance, the resource allocation for an interleaved PDCCH for a CORESET 0 may not begin on an integer multiple of 6, resulting in a C-Plane message using an increased a number of sections and/or section descriptions (e.g., as described below with regards to FIGS. 6, 7, and 8) to indicate the resource allocation configuration and, consequently, increased message resource consumption (e.g., air interface resources) by the C-Plane message. Increased message resource consumption may lead to fewer message resources being available for other O-RAN messages, resulting in slower communication transfers (e.g., increased communication latencies), reduced data throughput, and/or congestion within the O-RAN.

Some techniques and apparatuses described herein provide reduction to a C-Plane section size for interleaved PDCCH CORESET 0. In some aspects, a DU may receive an indication that an RU supports a C-Plane section size reduction format. Based at least in part on receiving the indication, the DU may generate a C-Plane message based at least in part on using the C-Plane section size reduction format. A first example of a C-Plane section size reduction format may include configuring an SE-6 and/or an SE-12 in a C-Plane message based at least in part on C-Plane section reduction validation logic and/or a C-Plane section size reduction equation, and a second example of a C-Plane section size reduction format may include a C-Plane interleaved PDCCH CORESET 0 extension (e.g., that is not an SE-6 and/or an SE-12) in the C-Plane message, as described below. Based at least in part on generating the C-Plane message using the C-Plane section size reduction format, the DU may transmit a C-Plane message that indicates a resource allocation for an interleaved PDCCH CORESET 0 using fewer communication resources, relative to another C-Plane message that is generated using baseline calculations as described above.

In some aspects, an RU may transmit an indication that the RU supports a C-Plane section size reduction format, such as an SE-6 and/or an SE-12 that is based at least in part on C-Plane section reduction validation logic and/or a C-Plane section size reduction equation. As another example, the RU may support a C-Plane interleaved PDCCH CORESET 0 extension. Based at least in part on transmitting the indication, the RU may receive a C-Plane message that uses the C-Plane section size reduction format. In some aspects, the C-Plane message may indicate a resource allocation for an interleaved PDCCH CORESET 0 using fewer sections and, consequently, fewer communication resources, relative to a another C-Plane message that is based at least in part on the baseline calculations described above.

By using a C-Plane section size reduction format in a C-Plane message to indicate an interleaved PDCCH CORESET 0, a DU may transmit a first C-Plane message that uses fewer sections and, consequently, fewer communication resources, relative to a second C-Plane message that is generated using the baseline calculations. Using fewer communication resources may reduce message resource consumption (e.g., air interface resources) by the C-Plane message, increase a number of message resources being available for other O-RAN messages, reduce communication transfer latencies, increase data throughput, and/or reduce congestion within the O-RAN.

As indicated above, FIGS. 4A and 4B are provided as examples. Other examples may differ from what is described with regard to FIGS. 4A and 4B.

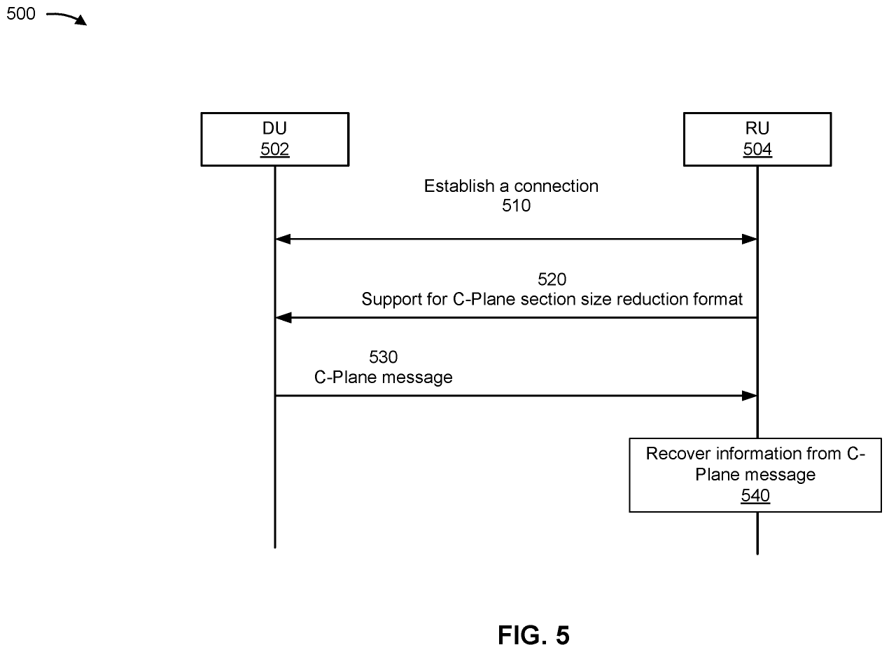

FIG. 5 is a diagram illustrating an example 500 of a wireless communication process between a DU 502 (e.g., a first network node 110) and an RU 504 (e.g., a second network node 110), in accordance with the present disclosure.

As shown by reference number 510, a DU 502 and an RU 504 may establish a connection. In some aspects, the DU 502 and the RU 504 may establish the connection using a wired link. In other aspects, the DU 502 and the RU 504 may establish the connection using a wireless link. As described with regard to FIG. 3, the connection between the DU 502 and the RU 504 may be established as a fronthaul link. Alternatively, or additionally, the DU 502 and the RU 504 may communicate with one another using the connection (e.g., the fronthaul link) and any combination of one or more C-Plane messages, one or more M-Plane messages, and/or one or more U-Plane messages.

As shown by reference number 520, the RU 504 may communicate, and the DU 502 may receive, an indication that the RU supports a C-Plane section size reduction format. As one example, the RU 504 may transmit an M-Plane message that indicates that the RU 504 supports the C-Plane section size reduction format. To illustrate, the M-Plane message may include a flag, such as an se6-coreset0-handling-supported flag, that may be set to a first value (e.g., “1”) that indicates that the RU 504 supports the C-Plane section size reduction format (e.g., for interleaved PDCCH CORESET 0 configuration). Alternatively, or additionally, the flag may be set to a second value (e.g., “0”) that indicates that the RU 504 does not support the C-Plane section size reduction format. In some aspects, the inclusion of the flag in the M-Plane message may indicate (e.g., implicitly) that the RU 504 supports the C-Plane section size reduction format and/or the exclusion of the flag in the M-Plane message may indicate (e.g., implicitly) that the RU 504 does not support the C-Plane section size reduction format. For instance, the M-Plane message may be a capability message that may include an optional flag (e.g., an optional se6-coreset0-handling-supported flag) whose presence in the M-Plane indicates support for the C-Plane section size reduction format and/or whose absence in the M-Plane indicates no support for the C-Plane section size reduction format.

As shown by reference number 530, the DU 502 may communicate (e.g., via a wireless link and/or via wired link), and the RU 504 may receive, a C-Plane message that uses the C-Plane section size reduction format. For example, the DU 502 may generate a C-Plane message that indicates a resource allocation configuration of an interleaved PDCCH CORESET 0, and the C-Plane message may indicate the resource allocation configuration using the C-Plane section size reduction format. In some aspects, the DU 502 may validate and/or verify whether the resource allocation configuration of the interleaved PDCCH CORESET 0 is a candidate for using the reduced C-Plane section size format using the following C-Plane section reduction validation logic:
startPrbc mod 6 !=0 and start_RB mod rbgSize !=0
numPrbc=24 or 48 or 96
numSymbol=1 or 2 or 3
   That is, as shown by the first logic statement, the DU 502 may verify that a starting PRB (e.g., startPrbc), and/or an index value of the starting PRB of a resource grid in the resource allocation, is not an integer multiple of 6. Alternatively, or additionally, the DU 502 may verify that a starting RB (e.g., start_RB), and/or an index value of the starting RB of the resource allocation, is not an integer multiple of a resource block group size (e.g., rbgSize). In some aspects, as shown by the second logical statement, the DU 502 may verify that a number of PRBs in the resource grid is a particular number: 24, 48, or 96. Alternatively, or additionally, the DU 502 may verify that a duration of the resource allocation is a particular number of symbols: e.g., 1 symbol, 2 symbols, or 3 symbols. Based at least in part on verifying that the starting PRB is not the integer multiple of 6 and the starting resource block is not the integer multiple of the resource block group size, based at least in part on verifying that the number of PRBs is the particular number, and/or based at least in part on verifying that the duration is the particular number of symbols, the DU 502 may generate the C-Plane message using the C-Plane section size reduction format.

As part of generating the C-Plane message using the C-Plane section size reduction format, the DU 502 may include a SE-6 and/or an SE-12 in the C-Plane message and/or set one or more fields of the SE-6 and/or the SE-12 in the C-Plane message based at least in part on the following C-Plane section size reduction equation:

f(n)=rbgSize(0<=n<lastRbgid)

That is, by validating various aspects of the resource allocation configuration as described with regard to the validating logic above, the DU 502 may configure the C-Plane message and/or one or more fields of the C-Plane message (e.g., in an SE-6 and/or an SE-12) based at least in part on each RBG in the resource allocation having a same number of PRBs as indicated by the C-Plane section size reduction equation and, consequently, use fewer C-Plane sections, as described below with regard to FIGS. 6, 7, and 8. Accordingly, as part of generating the C-Plane message, the DU 502 may set an RBG size field in the C-Plane message (e.g., an rbgSize field) to indicate the same number (e.g., the number of PRBs in each RBG in the resource allocation).

Alternatively, or additionally, the DU 502 may generate the C-Plane message using the C-Plane section size reduction format based at least in part on using a section extension that is configured based at least in part on the C-Plane section size reduction format. To illustrate, the DU 502 may include a C-Plane interleaved PDCCH CORESET 0 extension in the C-Plane message, where the C-Plane interleaved PDCCH CORESET 0 extension is not an SE-6 or an SE-12.

As shown by reference number 540, the RU 504 may recover information from the C-Plane message, such as by recovering information using the C-Plane section size reduction format. For instance, the C-Plane message may indicate the inclusion of a first section extension (e.g., an SE-6 and/or an SE-12) included in the C-Plane message that is formatted using the C-Plane section size reduction format. Alternatively, or additionally, the C-Plane message may indicate the inclusion of a second extension (e.g., a C-Plane interleaved PDCCH CORESET 0 extension), such as through a value in an extension type (e.g., extType) field. In some aspects, the RU 504 may derive that the C-Plane message is configured with the C-Plane section size reduction format, such as through the use of the validation logic. In some aspects, the RU 504 may recover information from the C-Plane message based at least in part on using the C-Plane section size reduction format, and/or may configure transmission and/or reception of a wireless communication using the information.

By using a C-Plane section size reduction format in a C-Plane message to indicate an interleaved PDCCH CORESET 0, a DU may transmit a first C-Plane message that uses fewer sections and, consequently, fewer communication resources, relative to a second C-Plane message that is generated using the baseline calculations. Using fewer communication resources may reduce message resource consumption (e.g., air interface resources) by the C-Plane message, increase a number of message resources being available for other O-RAN messages, reduce communication transfer latencies, increase data throughput, and/or reduce congestion within the O-RAN.

As indicated above, FIG. 5 is provided as an example. Other examples may differ from what is described with regard to FIG. 5.

FIG. 6 is a diagram illustrating an example 600 of a chart that illustrates a comparison of various RBG sizes that may be used in a C-Plane message to indicate example PRB partitions of an interleaved PDCCH CORESET 0 in a C-Plane message, in accordance with the present disclosure.

The example 600 is based at least in part on a first operating configuration of an interleaved PDCCH CORESET 0 allocation configuration that uses 30 kilohertz (kHz) subcarrier spacing (SCS), has an initial BWP that is positioned at PRB 8 to PRB 55 (e.g., the initial BWP spans 8-55 PRBs), has an synchronization signal block (SSB) that is positioned at PRB 20 to PRB 39 (e.g., spans 20-39 PRBs), and has a PDCCH system information block (SIB) configuration of 208 that indicates a time domain allocation and a frequency domain allocation of the PDCCH CORESET 0. Based at least in part on one or more operating conditions specified by a communication standard, the first operating configuration may also include the interleaved PDCCH CORESET 0 resource allocation including a number of RBs that totals 48, spanning symbols 0 and 1, and has a starting RB at an offset of 12.

Based at least in part on the first operating configuration, an interleaved PDCCH configured with an aggregation level (AL) of four (4) may result in a CORESET 0 resource allocation that uses a first partition of PRBs that spans PRB 8 to PRB 10 (e.g., 3 consecutive PRBs), a second partition that spans PRB 29 to PRB 34 (e.g., 6 consecutive PRBs), and a third partition that spans PRB 53 to PRB 55 (e.g., 3 consecutive PRBs). A total number of PRBs in the allocation=12.

The chart in the example 600 provides a comparison of varying Rbgsizes that may be used to indicate the CORESET 0 partitions via a section and/or an SE-6 format in a C-Plane message. More particularly, the chart is based at least in part on the baseline calculations described with regard to FIG. 4 (e.g., that do not reduce a number of sections included in a C-Plane message), which are replicated below:

f(0)=rbgSize−(startPrbc mod rbgSize)

f(n)=rbgSize, where 0<n<lastRbgid

if (startPrbc+numPrbc)mod rbgSize>0 then

f(lastRbgid)=(startPrbc+numPrbc)mod rbgSize

else

f(lastRbgid)=rbgSize

As described above, Rbgsize indicates a size and/or a number of PRBs in an RBG allocated by a bit mask, f(0) (shown in a second column of the chart) indicates a number of PRBs included in RBG 0, f(n) indicates a number of PRBs included in an n-th RBG, and f(L) indicates a number of RBGs in a lastRbgid (e.g., RBG L, L being an integer of the last RBG index).

A first row of the chart describes a configuration that includes Rbgsize=16. As shown by FIG. 6, Rbgsize=16 may not be used to indicate the above CORESET 0 resource allocation based at least in part on the largest partition of the allocation (e.g., the second partition) including 6 RBGs, and Rbgsize=16 exceeding 6.

In a similar manner, a second row of the chart describes a configuration that includes Rbgsize=8. As shown by FIG. 6, Rbgsize=8 may not be used to indicate the above CORESET 0 resource allocation based at least in part on the largest partition of the allocation (e.g., the second partition) including 6 RBGs, and Rbgsize=8 exceeds this value.

A third row of the chart describes a configuration that includes Rbgsize=6. Using baseline calculations described above (e.g., that do not reduce a number of sections included in a C-Plane message), f(0)=4, f(n)=6, and f(L)=2. However, f(0)=4 may not be used to represent the first partition that includes 3 PRBs.

A fourth row of the chart describes a configuration that includes Rbgsize=4. Using the baseline calculations described above, f(0)=4, f(n)=4, and f(L)=4. However, f(0)=4 may not be used to represent the first partition that includes 3 PRBs. Alternatively, or additionally, f(L)=4 may not be used to represent the last partition that includes 3 PRBs.

A fifth row of the chart describes a configuration that includes Rbgsize=3. Using the baseline calculations described above, f(0)=1, f(n)=3, and f(L)=2. However, f(0)=1 may not be used to represent the first partition that includes 3 PRBs. Alternatively, or additionally, f(n)=3 may not be used to represent the second partition that includes 6 PRBs.

A sixth row of the chart describes a configuration that includes Rbgsize=2. Using the baseline calculations described above, f(0)=2, f(n)=2, and f(L)=2. However, f(0)=2 may not be used to represent the first partition that includes 3 PRBs.

A seventh row of the chart describes a configuration that includes Rbgsize=1. Using calculations described above that do not reduce a number of sections included in a C-Plane message, f(0)=1, f(n)=1, and f(L)=1. Rbgsize=1 may be used to represent all of the above partitions of the CORESET 0 resource allocation (e.g., the first partition, the second partition, and the third partition) in a C-Plane message using one or more SE-6 formats, but multiple sections may be used. More particularly, at least two sections may be used in the C-Plane message to represent the above partitions of the CORESET 0. To illustrate, the number of PRBs of the first operating configuration span across 48 PRBs (e.g., PRB 8 to PRB 55), and an rbgMask in a single C-plane section may allow and/or indicate 28 PRBs with a size of 1. Accordingly, two sections include two rbgMasks that can each indicate up to 28 PRBs, totaling 56 PRBs.

As an alternative, a C-Plane message may be configured using a C-Plane section size reduction format based at least in part on the interleaved PDCCH CORESET 0 resource allocation satisfying the C-Plane section reduction validation logic described above and replicated below:
startPrbc mod 6 !=0 and start_RB mod rbgSize !=0
numPrbc=24 or 48 or 96
numSymbol=1 or 2 or 3
   For the first configuration, startPrbc=8, start_RB=12, numPrbc=48, and numSymbol=2. For an RbgSize=3, the above interleaved PDCCH CORESET 0 resource allocation may be indicated in one section of a C-Plane message based at least in part on the C-Plane section size reduction equation described above and replicated below:

f(n)=rbgSize(0<=n<lastRbgid)

That is, the above interleaved PDCCH CORESET 0 resource allocation may be indicated in one section of a C-Plane message based at least in part on each RB having a same number of PRBs (e.g., RbgSize=3).

As indicated above, FIG. 6 is provided as an example. Other examples may differ from what is described with regard to FIG. 6.

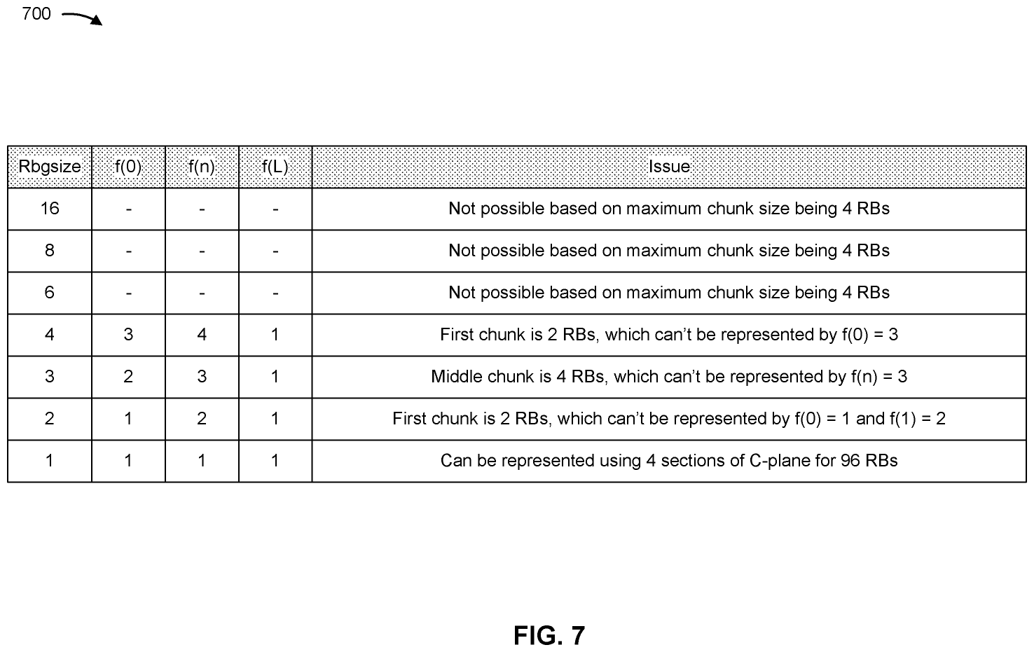

FIG. 7 is a diagram illustrating an example 700 of a chart that illustrates a comparison of various RBG sizes that may be used in a C-Plane message to indicate example PRB partitions of an interleaved PDCCH CORESET 0 in a C-Plane message, in accordance with the present disclosure.

The example 700 includes a second operating configuration of an interleaved PDCCH CORESET 0 resource allocation that uses 15 kHz SCS, uses an initial BWP that spans at PRB 85 to PRB 180, has an SSB configuration that spans PRB 123 to PRB 142, and/or uses a PDCCH SIB configuration of 224. Based at least in part on one or more operating conditions specified by a communication standard, the second operating configuration may also be based at least in part on the interleaved PDCCH CORESET 0 resource allocation including a number of RBs that totals 48, spanning symbols 0 and 1, and has a starting RB at an offset of 14.

Using the second operating configuration, an interleaved PDCCH configured with an AL of 4 may result in a CORESET 0 resource allocation that uses a first partition of PRBs that includes PRBs 85-86 (e.g., 2 consecutive PRBs), a second partition of PRBs that includes PRBs 131-134 (e.g., 4 consecutive PRBs), and a third partition of PRBs that includes PRBs 170-180 (e.g., 2 consecutive PRBs).

The chart in the example 700 provides a comparison between varying Rbgsizes that may be used to indicate the CORESET 0 partitions described above with regard to the second operating configuration using an SE-6 format in a C-Plane message. In a similar manner as the example 600, the chart in the example 700 is based at least in part on baseline calculations described with regard to FIG. 4.

A first row of the chart describes a configuration that includes Rbgsize=16. As shown by FIG. 7, Rbgsize=16 may not be used to indicate the above CORESET 0 based at least in part on the largest partition of the allocation (e.g., the second partition) including 4 PRBs, and Rbgsize=16 exceeding this value. In a similar manner, a second row of the chart describes a configuration that includes Rbgsize=8, and a third row of the chart described a configuration that uses Rbgsize=6. As shown in FIG. 7, neither Rbgsize=8 or Rbgsize=6 may be used to indicate a configuration of the above CORESET 0 based at least in part on the largest partition of the allocation (e.g., the second partition) including 4 PRBs. That is, Rbgsize=8 and Rbgsize=6 both exceed the 4 RBG value.

A fourth row of the chart describes a configuration that includes Rbgsize=6. Using calculations described above that do not reduce a number of sections included in a C-Plane message, f(0)=3, f(n)=4, and f(L)=2. However, f(0)=3 may not be used to represent the first partition that includes 2 PRBs.

A fifth row of the chart describes a configuration that includes Rbgsize=2. Using calculations described above that do not reduce a number of sections included in a C-Plane message, f(0)=2, f(n)=3, and f(L)=1. However, f(n)=3 may not be used to represent the second partition that includes 4 PRBs.

A sixth row of the chart describes a configuration that includes Rbgsize=2. Using calculations described above that do not reduce a number of sections included in a C-Plane message, f(0)=1, f(n)=2, and f(L)=1. However, f(0)=1 in combination with f(1)=2 may not be used to represent the first partition that includes 2 PRBs.

A seventh row of the chart describes a configuration that includes Rbgsize=1. Using calculations described above that do not reduce a number of sections included in a C-Plane message, f(0)=1, f(n)=1, and f(L)=1. Rbgsize=1 may be used to represent the above partitions of the CORESET 0 (e.g., the first partition, the second partition, and the third partition) in a C-Plane message using one or more SE-6 formats, but multiple sections may be used. More particularly, at least four sections may be used in the C-Plane message to represent the above partitions of the CORESET 0. To illustrate, the number of PRBs of the second operating configuration span across 96 PRBs (e.g., PRB 85 to PRB 180), and an rbgMask in a single C-plane section may allow and/or indicate 28 PRBs with a size of 1. Accordingly, four sections include four rbgMasks that can each indicate up to 28 PRBs, totaling 112 PRBs.

As an alternative, a C-Plane message may be configured using a C-Plane section size reduction format based at least in part on the interleaved PDCCH CORESET 0 resource allocation satisfying the C-Plane section reduction validation logic described above. For the second configuration, startPrbc=85, start_RB=14, numPrbc=48, and numSymbol=2. For an RbgSize=2, the above interleaved PDCCH CORESET 0 resource allocation may be indicated in two sections of a C-Plane message based at least in part on the C-Plane section size reduction equation described above. Accordingly, based at least in part on using the C-Plane section size reduction format, the above interleaved PDCCH CORESET 0 resource allocation may be indicated in two sections of a C-Plane message based at least in part on each RB having a same number of PRBs (e.g., RbgSize=2).

As indicated above, FIG. 7 is provided as an example. Other examples may differ from what is described with regard to FIG. 7.

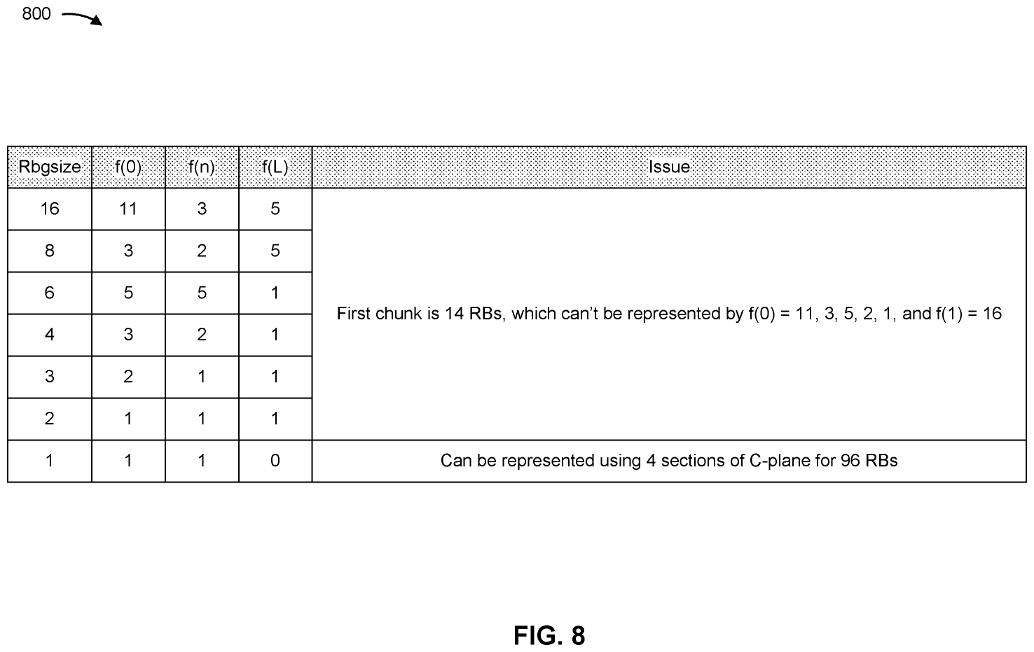

FIG. 8 is a diagram illustrating an example 800 of a chart that illustrates a comparison of various RBG sizes that may be used in a C-Plane message to indicate example PRB partitions of an interleaved PDCCH CORESET 0 in the C-Plane message, in accordance with the present disclosure.

The example 800 is based at least in part on a third operating configuration of an interleaved PDCCH CORESET 0 resource allocation that uses a 15 kHz SCS, uses an initial BWP that spans PRB 85 to PRB 180, has an SSB configuration that spans PRB 123 to PRB 142, and/or uses a PDCCH SIB configuration of 224. Based at least in part on one or more operating conditions specified by a communication standard, the third operating configuration may also be based at least in part on the interleaved PDCCH CORESET 0 resource allocation including a number of RBs that totals 48, spanning symbols 0 and 1, and has a starting RB at an offset of 14.

Based at least in part on the third operating configuration, an interleaved PDCCH configured with an AL of 16 may result in a CORESET 0 that uses a first partition of PRBs that includes PRBs 85-98 (e.g., 14 consecutive PRBs), a second partition that includes PRBs 131-146 (e.g., 16 consecutive PRBs), and a third partition that includes PRBs 179-180 (e.g., 2 consecutive PRBs).

In a similar manner as the example 600 and/or the example 700, the chart in the example 800 is based at least in part on the baseline calculations described with regard to FIG. 4 (e.g., that do not reduce a number of sections included in a C-Plane message). Row 1 to Row 6 of the chart in the example 800 compare Rbgsize=16, Rbgsize=8, Rbgsize=6, Rbgsize=4, Rbgsize=3, and Rbgsize=2, respectively, to a respective number of PRBs in a respective RBG (e.g., f(0), f(n) and f(L)) as calculated by the baseline calculations. As shown in FIG. 8, Rbgsize=16, Rbgsize=8, Rbgsize=6, Rbgsize=4, Rbgsize=3, and Rbgsize=2 may not be used to indicate the above CORESET 0 described with regard to the example 800 based at least in part on the first partition including 14 PRBs and/or the second partition including 16 PRBs

A seventh row of the chart describes a configuration that includes Rbgsize=1. Using the baseline calculations, f(0)=1, f(n)=1, and f(L)=0. Accordingly, Rbgsize=1 may be used to represent the above partitions of the CORESET 0 (e.g., the first partition, the second partition, and the third partition) in a C-Plane message using one or more SE-6 formats, but multiple sections may be used. More particularly, at least four sections may be used in the C-Plane message to represent the above partitions of the CORESET 0. To illustrate, the number of PRBs of the third operating configuration span across 96 PRBs (e.g., PRB 85 to PRB 180), and an rbgMask in a single C-plane section may allow and/or indicate 28 PRBs with a size of 1. Accordingly, four sections include four rbgMasks that can each indicate up to 28 PRBs, totaling 112 PRBs.

Conversely, a C-Plane message may be configured using a C-Plane section size reduction format based at least in part on the interleaved PDCCH CORESET 0 resource allocation satisfying the C-Plane section reduction validation logic described above. For the third operating configuration, startPrbc=85, start_RB=14, numPrbc=48, and numSymbol=2. For an RbgSize=2, the above interleaved PDCCH CORESET 0 resource allocation may be indicated in two sections of a C-Plane message based at least in part on the C-Plane section size reduction equation described above. Accordingly, based at least in part on using the C-Plane section size reduction format, the above interleaved PDCCH CORESET 0 resource allocation may be indicated in two sections of a C-Plane message based at least in part on each RB having a same number of PRBs (e.g., RbgSize=2).

As indicated above, FIG. 8 is provided as an example. Other examples may differ from what is described with regard to FIG. 8.

FIG. 9 is a diagram illustrating an example process 900 performed, for example, at a DU or an apparatus of a DU, in accordance with the present disclosure. Example process 900 is an example where the apparatus or the DU (e.g., a network node 110 and/or a DU 330) performs operations associated with reduction of a C-Plane section size for an interleaved PDCCH CORESET 0.

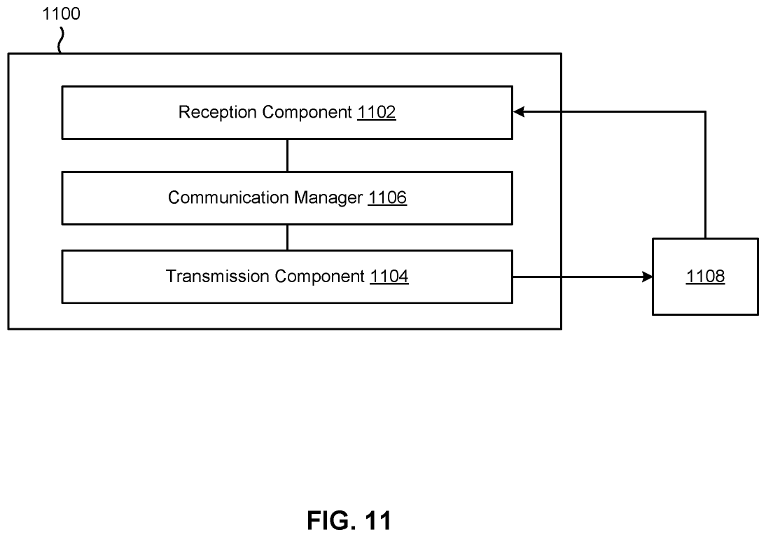

As shown in FIG. 9, in some aspects, process 900 may include receiving an indication that an RU supports a C-Plane section size reduction format (block 910). For example, the DU (e.g., using reception component 1102 and/or communication manager 1106, depicted in FIG. 11) may receive an indication that an RU supports a C-Plane section size reduction format, as described above.

As further shown in FIG. 9, in some aspects, process 900 may include transmitting, based at least in part on receiving the indication, a C-Plane message that uses the C-Plane section size reduction format, the C-Plane message indicating a resource allocation for an interleaved PDCCH CORESET 0 (block 920). For example, the DU (e.g., using transmission component 1104 and/or communication manager 1106, depicted in FIG. 11) may transmit, based at least in part on receiving the indication, a C-Plane message that uses the C-Plane section size reduction format, the C-Plane message indicating a resource allocation for an interleaved PDCCH CORESET 0, as described above.

Process 900 may include additional aspects, such as any single aspect or any combination of aspects described below and/or in connection with one or more other processes described elsewhere herein.

In a first aspect, receiving the indication includes receiving the indication in an M-Plane message.

In a second aspect, the indication is a flag in an M-Plane message.

In a third aspect, the flag includes an se6-coreset0-handling-supported flag.

In a fourth aspect, the C-Plane message includes a section extension 6.

In a fifth aspect, process 900 includes verifying that a starting PRB of a resource grid in the resource allocation is not an integer multiple of 6 and that a starting resource block is not an integer multiple of a resource block group size, and generating the C-Plane message using the C-Plane section size reduction format based at least in part on verifying that the starting PRB is not the integer multiple of 6 and the starting resource block is not the integer multiple of the resource block group size.

In a sixth aspect, process 900 includes verifying that a number of PRBs in the resource grid is a particular number, the particular number being 24, 48, or 96, and generating the C-Plane message using the C-Plane section size reduction format is based at least in part on verifying that the number of PRBs is the particular number.

In a seventh aspect, process 900 includes verifying that a duration of the resource allocation is a particular number of symbols, the particular number of symbols being 1 symbol, 2 symbols, or 3 symbols, and generating the C-Plane message using the C-Plane section size reduction format is based at least in part on verifying that the duration of the resource allocation is the particular number of symbols.

In an eighth aspect, process 900 includes configuring each resource block group in the resource allocation to have a same number of PRBs based at least in part on verifying that the starting PRB is not the integer multiple of 6 and the starting resource block is not the integer multiple of the resource block group size, verifying that the number of PRBs is the particular number, and verifying that the duration is the particular number of symbols, and configuring a resource block group size field in the C-Plane message to indicate the same number.

In a ninth aspect, process 900 includes generating the C-Plane message using the C-Plane section size reduction format based at least in part on using a section extension that is configured based at least in part on the C-Plane section size reduction format.

In a tenth aspect, the section extension is not an SE-6 or an SE-12.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at an RU or an apparatus of an RU, in accordance with the present disclosure. Example process 1000 is an example where the apparatus or the RU (e.g., a network node 110 and/or an RU 340) performs operations associated with reduction of a C-Plane section size for an interleaved PDCCH CORESET 0.

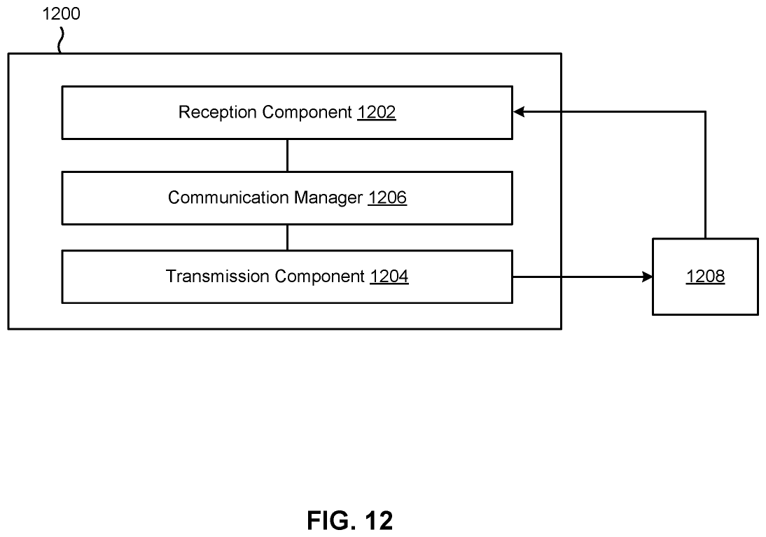

As shown in FIG. 10, in some aspects, process 1000 may include transmitting an indication that the RU supports a C-Plane section size reduction format (block 1010). For example, the RU (e.g., using transmission component 1204 and/or communication manager 1206, depicted in FIG. 12) may transmit an indication that the RU supports a C-Plane section size reduction format, as described above.

As further shown in FIG. 10, in some aspects, process 1000 may include receiving, based at least in part on receiving the indication, a C-Plane message that uses the C-Plane section size reduction format, the C-Plane message indicating a resource allocation for an interleaved PDCCH CORESET 0 (block 1020). For example, the RU (e.g., using reception component 1202 and/or communication manager 1206, depicted in FIG. 12) may receive, based at least in part on receiving the indication, a C-Plane message that uses the C-Plane section size reduction format, the C-Plane message indicating a resource allocation for an interleaved PDCCH CORESET 0, as described above.

Process 1000 may include additional aspects, such as any single aspect or any combination of aspects described below and/or in connection with one or more other processes described elsewhere herein.

In a first aspect, transmitting the indication includes transmitting the indication in an M-Plane message.

In a second aspect, the indication is a flag in an M-Plane message.

In a third aspect, the flag includes an se6-coreset0-handling-supported flag.

In a fourth aspect, the C-Plane message includes a section extension 6.

In a fifth aspect, process 1000 includes verifying that a starting PRB of a resource grid in the resource allocation is not an integer multiple of 6 and that a starting resource block is not an integer multiple of a resource block group size, and recovering information from the C-Plane message using the C-Plane section size reduction format based at least in part on verifying that the starting PRB is not the integer multiple of 6 and the starting resource block is not the integer multiple of the resource block group size.

In a sixth aspect, process 1000 includes verifying that a number of PRBs in the resource grid is a particular number, the particular number being 24, 48, or 96, and recovering the information from the C-Plane message using the C-Plane section size reduction format is based at least in part on verifying the number of PRBs is the particular number.

In a seventh aspect, process 1000 includes verifying that a duration of the resource allocation is a particular number of symbols, the particular number of symbols being 1 symbol, 2 symbols, or 3 symbols, and recovering the C-Plane message using the C-Plane section size reduction format is based at least in part on verifying that the duration is the particular number of symbols.

In an eighth aspect, process 1000 includes determining each resource block group in the resource allocation includes a same number of PRBs based at least in part on verifying that the starting PRB is not the integer multiple of 6 and the starting resource block is not the integer multiple of the resource block group size, verifying that the number of PRBs is the particular number, and verifying that the duration is the particular number of symbols.

In a ninth aspect, a resource block group size field in the C-Plane message indicates the same number.

In a tenth aspect, process 1000 includes recovering the C-Plane message using the C-Plane section size reduction format based at least in part on using a section extension that is configured based at least in part on the C-Plane section size reduction format.

In an eleventh aspect, the section extension is not an SE-6 or an SE-12.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication, in accordance with the present disclosure. The apparatus 1100 may be a DU, or a DU may include the apparatus 1100. In some aspects, the apparatus 1100 includes a reception component 1102, a transmission component 1104, and/or a communication manager 1106, which may be in communication with one another (for example, via one or more buses and/or one or more other components). In some aspects, the communication manager 1106 is the communication manager 150 described in connection with FIG. 1. As shown, the apparatus 1100 may communicate with another apparatus 1108, such as a UE or a network node (such as a CU, a DU, an RU, or a base station), using the reception component 1102 and the transmission component 1104.

In some aspects, the apparatus 1100 may be configured to perform one or more operations described herein in connection with FIGS. 4B-8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the DU described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1102 may receive communications, such as reference signals, control information, data communications, or a combination thereof, from the apparatus 1108. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, one or more modems, one or more demodulators, one or more MIMO detectors, one or more receive processors, one or more controllers/processors, one or more memories, or a combination thereof, of the DU described in connection with FIG. 2.

The transmission component 1104 may transmit communications, such as reference signals, control information, data communications, or a combination thereof, to the apparatus 1108. In some aspects, one or more other components of the apparatus 1100 may generate communications and may provide the generated communications to the transmission component 1104 for transmission to the apparatus 1108. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1108. In some aspects, the transmission component 1104 may include one or more antennas, one or more modems, one or more modulators, one or more transmit MIMO processors, one or more transmit processors, one or more controllers/processors, one or more memories, or a combination thereof, of the DU described in connection with FIG. 2. In some aspects, the transmission component 1104 may be co-located with the reception component 1102 in one or more transceivers.

The communication manager 1106 may support operations of the reception component 1102 and/or the transmission component 1104. For example, the communication manager 1106 may receive information associated with configuring reception of communications by the reception component 1102 and/or transmission of communications by the transmission component 1104. Additionally, or alternatively, the communication manager 1106 may generate and/or provide control information to the reception component 1102 and/or the transmission component 1104 to control reception and/or transmission of communications.

The reception component 1102 may receive an indication that an RU supports a C-Plane section size reduction format. The transmission component 1104 may transmit, based at least in part on receiving the indication, a C-Plane message that uses the C-Plane section size reduction format, the C-Plane message indicating a resource allocation for an interleaved PDCCH CORESET 0.

The communication manager 1106 may verify that a starting PRB of a resource grid in the resource allocation is not an integer multiple of 6 and that a starting resource block is not an integer multiple of a resource block group size. Alternatively, or additionally, the communication manager 1106 may generate the C-Plane message using the C-Plane section size reduction format based at least in part on verifying that the starting PRB is not the integer multiple of 6 and the starting resource block is not the integer multiple of the resource block group size.

The communication manager 1106 may verify that a number of PRBs in the resource grid is a particular number, the particular number being 24, 48, or 96, and generating the C-Plane message using the C-Plane section size reduction format is based at least in part on verifying that the number of PRBs is the particular number. In some aspects, communication manager 1106 may verify that a duration of the resource allocation is a particular number of symbols, the particular number of symbols being 1 symbol, 2 symbols, or 3 symbols, and generating the C-Plane message using the C-Plane section size reduction format is based at least in part on verifying that the duration of the resource allocation is the particular number of symbols.

The communication manager 1106 may configure each resource block group in the resource allocation to have a same number of PRBs based at least in part on verifying that the starting PRB is not the integer multiple of 6 and the starting resource block is not the integer multiple of the resource block group size, verifying the number of PRBs is the particular number, and verifying that the duration is the particular number of symbols. Alternatively, or additionally, the communication manager 1106 may configure a resource block group size field in the C-Plane message to indicate the same number. In some aspects, the communication manager 1106 may generate the C-Plane message using the C-Plane section size reduction format based at least in part on using a section extension that is configured based at least in part on the C-Plane section size reduction format.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication, in accordance with the present disclosure. The apparatus 1200 may be an RU, or an RU may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 150 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 4B-8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the RU described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the RU described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the RU described in connection with FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The transmission component 1204 may transmit an indication that the RU supports a C-Plane section size reduction format. The reception component 1202 may receive, based at least in part on receiving the indication, a C-Plane message that uses the C-Plane section size reduction format, the C-Plane message indicating a resource allocation for an interleaved PDCCH CORESET 0.

The communication manager 1206 may verify that a starting PRB of a resource grid in the resource allocation is not an integer multiple of 6 and that a starting resource block is not an integer multiple of a resource block group size. Alternatively, or additionally, the communication manager 1206 may recover information from the C-Plane message using the C-Plane section size reduction format based at least in part on verifying that the starting PRB is not the integer multiple of 6 and the starting resource block is not the integer multiple of the resource block group size.

The communication manager 1206 may verify that a number of PRBs in the resource grid is a particular number, the particular number being 24, 48, or 96, and recovering the information from the C-Plane message using the C-Plane section size reduction format is based at least in part on verifying that the number of PRBs is the particular number. In some aspects, the communication manager 1206 may verify that a duration of the resource allocation is a particular number of symbols, the particular number of symbols being 1 symbol, 2 symbols, or 3 symbols, and recovering the C-Plane message using the C-Plane section size reduction format is based at least in part on verifying that the duration is the particular number of symbols.

The communication manager 1206 may determine that each resource block group in the resource allocation includes a same number of PRBs based at least in part on verifying that the starting PRB is not the integer multiple of 6 and the starting resource block is not the integer multiple of the resource block group size, verifying that the number of PRBs is the particular number, and verifying that the duration is the particular number of symbols. Alternatively, or additionally, the communication manager 1206 may recover the C-Plane message using the C-Plane section size reduction format based at least in part on using a section extension that is configured based at least in part on the C-Plane section size reduction format.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:

Aspect 1: A method of wireless communication performed by a distributed unit (DU), comprising: receiving an indication that a radio unit (RU) supports a control plane (C-Plane) section size reduction format; and transmitting, based at least in part on receiving the indication, a C-Plane message that uses the C-Plane section size reduction format, the C-Plane message indicating a resource allocation for an interleaved physical downlink control channel (PDCCH) control resource set (CORESET) 0.

Aspect 2: The method of Aspect 1, wherein receiving the indication comprises: receiving the indication in a management plane (M-Plane) message.

Aspect 3: The method of Aspect 2, wherein the indication is a flag in an M-Plane message.

Aspect 4: The method of Aspect 3, wherein the flag comprises an se6-coreset0-handling-supported flag.

Aspect 5: The method of any of Aspects 1-4, wherein the C-Plane message includes a section extension 6.

Aspect 6: The method of Aspect 5, further comprising: verifying that a starting physical resource block (PRB) of a resource grid in the resource allocation is not an integer multiple of six (6) and that a starting resource block is not an integer multiple of a resource block group size; and generating the C-Plane message using the C-Plane section size reduction format based at least in part on verifying that the starting PRB is not the integer multiple of 6 and the starting resource block is not the integer multiple of the resource block group size.

Aspect 7: The method of Aspect 6, further comprising: verifying that a number of PRBs in the resource grid is a particular number, the particular number being 24, 48, or 96, wherein generating the C-Plane message using the C-Plane section size reduction format is based at least in part on verifying the number of PRBs is the particular number.

Aspect 8: The method of Aspect 7, further comprising: verifying that a duration of the resource allocation is a particular number of symbols, the particular number of symbols being 1 symbol, 2 symbols, or 3 symbols, wherein generating the C-Plane message using the C-Plane section size reduction format is based at least in part on verifying the duration of the resource allocation is the particular number of symbols.

Aspect 9: The method of Aspect 8, further comprising: configuring each resource block group in the resource allocation to have a same number of physical resource blocks (PRBs) based at least in part on verifying that the starting PRB is not the integer multiple of 6 and the starting resource block is not the integer multiple of the resource block group size, verifying the number of PRBs is the particular number, and verifying the duration is the particular number of symbols; and configuring a resource block group size field in the C-Plane message to indicate the same number.

Aspect 10: The method of any of Aspects 1-9, further comprising: generating the C-Plane message using the C-Plane section size reduction format based at least in part on using a section extension that is configured based at least in part on the C-Plane section size reduction format.

Aspect 11: The method of Aspect 10, wherein the section extension is not a section extension 6 (SE-6) or a section extension 12 (SE-12).

Aspect 12: A method of wireless communication performed by a radio unit (RU), comprising: transmitting an indication that the RU supports a control plane (C-Plane) section size reduction format; and receiving, based at least in part on receiving the indication, a C-Plane message that uses the C-Plane section size reduction format, the C-Plane message indicating a resource allocation for an interleaved physical downlink control channel (PDCCH) control resource set (CORESET) 0.

Aspect 13: The method of Aspect 12, wherein transmitting the indication comprises: transmitting the indication in a management plane (M-Plane) message.

Aspect 14: The method of Aspect 13, wherein the indication is a flag in an M-Plane message.

Aspect 15: The method of Aspect 14, wherein the flag comprises an se6-coreset0-handling-supported flag.

Aspect 16: The method of any of Aspects 12-15, wherein the C-Plane message includes a section extension 6.

Aspect 17: The method of Aspect 16, further comprising: verifying that a starting physical resource block (PRB) of a resource grid in the resource allocation is not an integer multiple of six (6) and that a starting resource block is not an integer multiple of a resource block group size; and recovering information from the C-Plane message using the C-Plane section size reduction format based at least in part on verifying that the starting PRB is not the integer multiple of 6 and the starting resource block is not the integer multiple of the resource block group size.

Aspect 18: The method of Aspect 17, further comprising: verifying that a number of PRBs in the resource grid is a particular number, the particular number being 24, 48, or 96, wherein recovering the information from the C-Plane message using the C-Plane section size reduction format is based at least in part on verifying the number of PRBs is the particular number.

Aspect 19: The method of Aspect 18, further comprising: verifying that a duration of the resource allocation is a particular number of symbols, the particular number of symbols being 1 symbol, 2 symbols, or 3 symbols, wherein recovering the C-Plane message using the C-Plane section size reduction format is based at least in part on verifying the duration is the particular number of symbols.

Aspect 20: The method of Aspect 19, further comprising: determining each resource block group in the resource allocation includes a same number of physical resource blocks (PRBs) based at least in part on verifying that the starting PRB is not the integer multiple of 6 and the starting resource block is not the integer multiple of the resource block group size, verifying the number of PRBs is the particular number, and verifying the duration is the particular number of symbols.

Aspect 21: The method of Aspect 20, wherein a resource block group size field in the C-Plane message indicates the same number.

Aspect 22: The method of any of Aspects 12-21, further comprising: recovering the C-Plane message using the C-Plane section size reduction format based at least in part on using a section extension that is configured based at least in part on the C-Plane section size reduction format.

Aspect 23: The method of Aspect 22, wherein the section extension is not a section extension 6 (SE-6) or a section extension 12 (SE-12).

Aspect 24: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-11.

Aspect 25: An apparatus for wireless communication at a device, the apparatus comprising one or more memories and one or more processors coupled to the one or more memories, the one or more processors configured to cause the device to perform the method of one or more of Aspects 1-11.

Aspect 26: An apparatus for wireless communication, the apparatus comprising at least one means for performing the method of one or more of Aspects 1-11.

Aspect 27: A non-transitory computer-readable medium storing code for wireless communication, the code comprising instructions executable by one or more processors to perform the method of one or more of Aspects 1-11.

Aspect 28: A non-transitory computer-readable medium storing a set of instructions for wireless communication, the set of instructions comprising one or more instructions that, when executed by one or more processors of a device, cause the device to perform the method of one or more of Aspects 1-11.

Aspect 29: A device for wireless communication, the device comprising a processing system that includes one or more processors and one or more memories coupled with the one or more processors, the processing system configured to cause the device to perform the method of one or more of Aspects 1-11.

Aspect 30: An apparatus for wireless communication at a device, the apparatus comprising one or more memories and one or more processors coupled to the one or more memories, the one or more processors individually or collectively configured to cause the device to perform the method of one or more of Aspects 1-11.

Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 12-23.

Aspect 32: An apparatus for wireless communication at a device, the apparatus comprising one or more memories and one or more processors coupled to the one or more memories, the one or more processors configured to cause the device to perform the method of one or more of Aspects 12-23.

Aspect 33: An apparatus for wireless communication, the apparatus comprising at least one means for performing the method of one or more of Aspects 12-23.

Aspect 34: A non-transitory computer-readable medium storing code for wireless communication, the code comprising instructions executable by one or more processors to perform the method of one or more of Aspects 12-23.

Aspect 35: A non-transitory computer-readable medium storing a set of instructions for wireless communication, the set of instructions comprising one or more instructions that, when executed by one or more processors of a device, cause the device to perform the method of one or more of Aspects 12-23.

Aspect 36: A device for wireless communication, the device comprising a processing system that includes one or more processors and one or more memories coupled with the one or more processors, the processing system configured to cause the device to perform the method of one or more of Aspects 12-23.

Aspect 37: An apparatus for wireless communication at a device, the apparatus comprising one or more memories and one or more processors coupled to the one or more memories, the one or more processors individually or collectively configured to cause the device to perform the method of one or more of Aspects 12-23.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a distributed unit (DU), comprising:
one or more memories; and
one or more processors, coupled to the one or more memories, configured to cause the DU to:
receive an indication that a radio unit (RU) supports a control plane (C-Plane) section size reduction format; and
transmit, based at least in part on receiving the indication, a C-Plane message that uses the C-Plane section size reduction format, the C-Plane message indicating a resource allocation for an interleaved physical downlink control channel (PDCCH) control resource set (CORESET) 0.

2. The apparatus of claim 1, wherein the one or more processors, to cause the DU to receive the indication, are configured to cause the DU to:
receive the indication in a management plane (M-Plane) message.

3. The apparatus of claim 1, wherein the C-Plane message includes a section extension 6.

4. The apparatus of claim 3, wherein the one or more processors are further configured to cause the DU to:
verify that a starting physical resource block (PRB) of a resource grid in the resource allocation is not an integer multiple of six (6) and that a starting resource block is not an integer multiple of a resource block group size; and
generate the C-Plane message using the C-Plane section size reduction format based at least in part on verifying that the starting PRB is not the integer multiple of 6 and the starting resource block is not the integer multiple of the resource block group size.

5. The apparatus of claim 4, wherein the one or more processors are further configured to cause the DU to:
verify that a number of PRBs in the resource grid is a particular number, the particular number being 24, 48, or 96,
wherein generating the C-Plane message using the C-Plane section size reduction format is based at least in part on verifying the number of PRBs is the particular number.

6. The apparatus of claim 5, wherein the one or more processors are further configured to cause the DU to:
verify that a duration of the resource allocation is a particular number of symbols, the particular number of symbols being 1 symbol, 2 symbols, or 3 symbols,
wherein generating the C-Plane message using the C-Plane section size reduction format is based at least in part on verifying the duration of the resource allocation is the particular number of symbols.

7. The apparatus of claim 6, wherein the one or more processors are further configured to cause the DU to:
configure each resource block group in the resource allocation to have a same number of physical resource blocks (PRBs) based at least in part on verifying that the starting PRB is not the integer multiple of 6 and the starting resource block is not the integer multiple of the resource block group size, verifying the number of PRBs is the particular number, and verifying the duration is the particular number of symbols; and
configure a resource block group size field in the C-Plane message to indicate the same number.

8. The apparatus of claim 1, wherein the one or more processors are further configured to cause the DU to:
generate the C-Plane message using the C-Plane section size reduction format based at least in part on using a section extension that is configured based at least in part on the C-Plane section size reduction format.

9. An apparatus for wireless communication at a radio unit (RU), comprising:
one or more memories; and
one or more processors, coupled to the one or more memories, configured to cause the RU to:
transmit an indication that the RU supports a control plane (C-Plane) section size reduction format; and
receive, based at least in part on receiving the indication, a C-Plane message that uses the C-Plane section size reduction format, the C-Plane message indicating a resource allocation for an interleaved physical downlink control channel (PDCCH) control resource set (CORESET) 0.

10. The apparatus of claim 9, wherein the one or more processors, to cause the RU to transmit the indication, are configured to cause the RU to:
transmit the indication in a management plane (M-Plane) message.

11. The apparatus of claim 9, wherein the C-Plane message includes a section extension 6.

12. The apparatus of claim 9, wherein the one or more processors are further configured to cause the RU to:
verify that a starting physical resource block (PRB) of a resource grid in the resource allocation is not an integer multiple of six (6) and that a starting resource block is not an integer multiple of a resource block group size; and
recover information from the C-Plane message using the C-Plane section size reduction format based at least in part on verifying that the starting PRB is not the integer multiple of 6 and the starting resource block is not the integer multiple of the resource block group size.

13. The apparatus of claim 12, wherein the one or more processors are further configured to cause the RU to:
verify that a number of PRBs in the resource grid is a particular number, the particular number being 24, 48, or 96,
wherein recovering the information from the C-Plane message using the C-Plane section size reduction format is based at least in part on verifying the number of PRBs is the particular number.

14. The apparatus of claim 13, wherein the one or more processors are further configured to cause the RU to:
verify that a duration of the resource allocation is a particular number of symbols, the particular number of symbols being 1 symbol, 2 symbols, or 3 symbols,
wherein recovering the C-Plane message using the C-Plane section size reduction format is based at least in part on verifying the duration is the particular number of symbols.

15. The apparatus of claim 14, wherein the one or more processors are further configured to cause the RU to:
determine each resource block group in the resource allocation includes a same number of physical resource blocks (PRBs) based at least in part on verifying that the starting PRB is not the integer multiple of 6 and the starting resource block is not the integer multiple of the resource block group size, verifying the number of PRBs is the particular number, and verifying the duration is the particular number of symbols.

16. The apparatus of claim 9, wherein the one or more processors are further configured to cause the RU to:
recover the C-Plane message using the C-Plane section size reduction format based at least in part on using a section extension that is configured based at least in part on the C-Plane section size reduction format.

17. A method of wireless communication performed by a distributed unit (DU), comprising:
receiving an indication that a radio unit (RU) supports a control plane (C-Plane) section size reduction format; and
transmitting, based at least in part on receiving the indication, a C-Plane message that uses the C-Plane section size reduction format, the C-Plane message indicating a resource allocation for an interleaved physical downlink control channel (PDCCH) control resource set (CORESET) 0.

18. The method of claim 17, wherein receiving the indication comprises:
receiving the indication in a management plane (M-Plane) message.

19. The method of claim 17, wherein the C-Plane message includes a section extension 6.

20. The method of claim 19, further comprising:
verifying that a starting physical resource block (PRB) of a resource grid in the resource allocation is not an integer multiple of six (6) and that a starting resource block is not an integer multiple of a resource block group size;
verifying that a number of PRBs in the resource grid is a particular number, the particular number being 24, 48, or 96;
verifying that a duration of the resource allocation is a particular number of symbols, the particular number of symbols being 1 symbol, 2 symbols, or 3 symbols; and
generating the C-Plane message using the C-Plane section size reduction format is based at least in part on verifying that the starting PRB is not the integer multiple of 6 and the starting resource block is not the integer multiple of the resource block group size, verifying the number of PRBs is the particular number, and verifying the duration is the particular number of symbols.
